(19) United States
(12) Patent Application Publication
(10) Pub. No.: US 2014/0148044 A1
(43) Pub. Date: May 29, 2014

(54) HARDLINE COAXIAL CONNECTOR WITH A LOCKING FERRULE

(71) Applicants: Anders Balcer, Vordingborg (DK); Jimmy Valentin Falster, Vordingborg (DK); Michael Meister, Langebaek (DK); Ebbe Koch Petersen, Kalvehave (DK)

(72) Inventors: Anders Balcer, Vordingborg (DK); Jimmy Valentin Falster, Vordingborg (DK); Michael Meister, Langebaek (DK); Ebbe Koch Petersen, Kalvehave (DK)

(21) Appl. No.: 13/795,737

(22) Filed: Mar. 12, 2013

Related U.S. Application Data
(60) Provisional application No. 61/731,121, filed on Nov. 29, 2012.

(51) Int. Cl. H01R 13/59

(52) U.S. Cl. CPC H01R 13/59
USPC 439/460

(57) ABSTRACT

A hardline coaxial cable connector is disclosed. The coaxial cable connector comprises an integral locking feature formed in one or both of a body and a ferrule. The integral locking feature is monolithic with at least one of the body and the ferrule. The integral locking feature may comprise cogs part of and monolithic with the body, and slots, flats, pegs or fins part of and monolithic with the ferrule. In this way, cogs engaging with the slots, the flats, the pegs, or the fins act to lock the ferrule in stable position, and, thereby, retain the cable in a stable, non-rotatable position in the connector.

### RELATED APPLICATIONS

This application claims the benefit of priority under 35 U.S.C. §119 of U.S. Provisional Application Ser. No. 61/731,121 filed on Nov. 29, 2012, the content of which is relied upon and incorporated herein by reference in its entirety.

This application is related to U.S. Application No. 61/583,385, filed Jan. 5, 2012, which is incorporated herein by reference in its entirety.

This application is related to U.S. Application No. 61/728,484, filed Nov. 20, 2012, which is incorporated herein by reference in its entirety.

### BACKGROUND

1. Field of the Disclosure

The disclosure relates generally to coaxial cable connectors, and particularly to a hardline connector with a ferrule.

2. Technical Background

A hardline coaxial cable typically has a solid center conductor surrounded by a plastic or other dielectric material and encased within an electrically conductive solid outer conductor that may be surrounded by an outer insulative jacket. In application, each end of the cable can be terminated by a connector, which serves to electrically and mechanically engage the cable conductors to communicate signals transmitted therethrough and for gripping the outer conductor to physically secure the cable and prevent detachment during normal operation and establishing electrical continuity.

Historically, connectors for hardline coaxial cables have been designed to grip the cable in such a manner as to be removed from the cable at a later time if so desired. Such a feature is generally known as “re-usability.” It is often the case in such connectors that a compressible ferrule is utilized to grip the cable outer conductor. Said ferrules are typically actuated by means of conically ramped components known as compression rings, which are often times moved axially closer together by means of a threaded coupler or nut. Rotation of the coupler system can impart a rotational force against the compression rings and be translated through the compression rings to the ferrule. As the ferrule is driven closed about the cable outer conductor the rotational force may then be translated to the cable outer conductor resulting in unwanted rotation or twist of the cable outer conductor in relation to the cable center conductor and connector components causing damage to the coaxial structure. In such connectors it is necessary to attempt to restrain the cable while tightening the connector components which is a difficult for a single installer. Two hands are typically required to manipulate the required wrenches and a third hand required to restrain the cable. Additionally, in some connectors it is possible for the cable to rotate within the connector after the connector components have been fully tightened because there is no positive means to adequately prevent the ferrule from slipping or rotating within the connector structure.

Previous attempts to provide a positive ferrule locking structure within a hardline coaxial cable connector have employed the use of a separate press-fit component resulting in unwanted higher cost.

### SUMMARY OF THE DETAILED DESCRIPTION

Embodiments disclosed herein include a hardline coaxial connector having an integral locking feature to prevent unwanted rotation or twist of the cable outer conductor in relation to the cable center conductor and connector components and, further, prevent cable rotation within the connector after the connector components have been fully tightened. The integral locking feature may include teeth or splines as a monolithic portion of the connector body and slots in the ferrule. The teeth or splines may position within the slots when the connector is closed and fully tightened to interlock with the ferrule.

Additional features and advantages are set out in the detailed description which follows, and in part will be readily apparent to those skilled in the art from that description or recognized by practicing the embodiments as described herein, including the detailed description, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross sectional view of a coaxial cable connector with a separate component to lock a ferrule;

FIG. 1A is a partial cross sectional view of the coaxial cable connector of FIG. 1 with a coaxial cable inserted therein;

FIG. 2 is a cross sectional view of an exemplary embodiment of a coaxial cable connector having an integral locking feature to lock the ferrule;

FIG. 3 is a perspective view of the coaxial cable connector of FIG. 2 showing ferrule with slots not engaged with cogs of body;

FIG. 4 is a perspective view of the coaxial cable connector of FIG. 2 showing ferrule with slots engaged with cogs of body;

FIG. 5 is a cross sectional view of the connector of FIG. 2 in a closed position with a cable installed therein;

FIG. 6 is a perspective view of an exemplary embodiment of a coaxial connector having an integral locking feature to lock the ferrule;

FIG. 7 is a perspective view of an exemplary embodiment of a coaxial connector having an integral locking feature to lock the ferrule;

FIG. 8 is a perspective view of an exemplary embodiment of a coaxial connector having an integral locking feature to lock the ferrule; and

FIG. 9 is a perspective view of an exemplary embodiment of a coaxial connector having an integral locking feature to lock the ferrule.

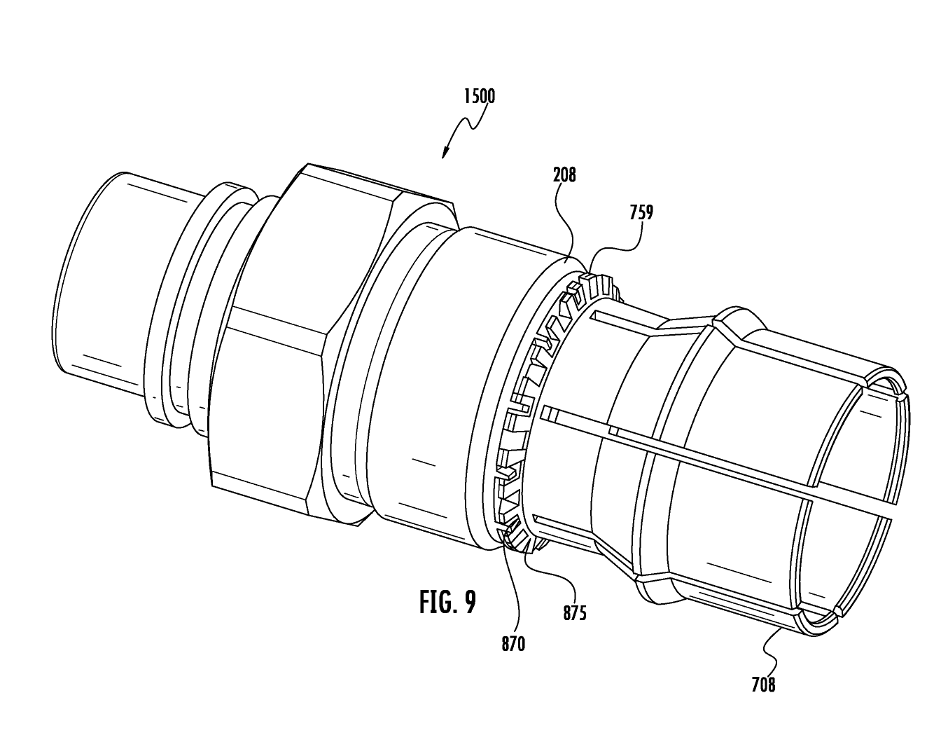

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein. Whenever possible, like reference numbers will be used to refer to like components or parts.

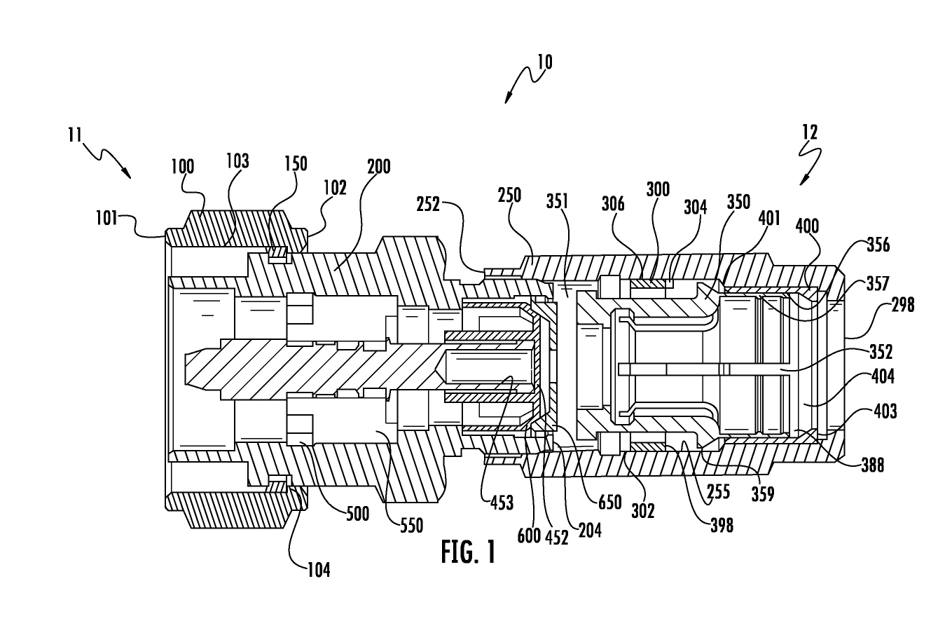

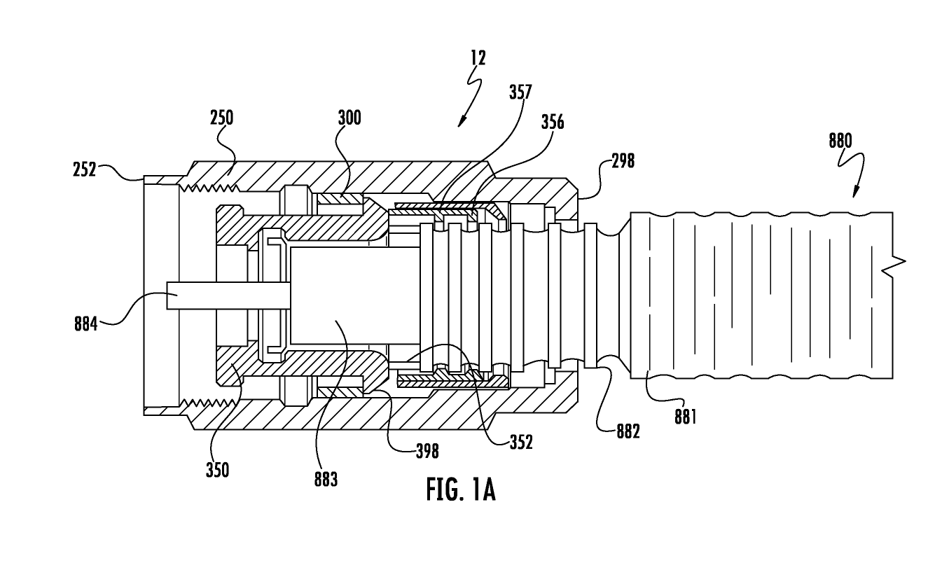

Referring to FIG. 1, a coaxial cable connector 10 having a separate component to lock a ferrule is illustrated. Connector 10 comprises front half 11 and back half 12, with front half 11 comprising coupler 100 rotationally connected to body 200 by split retainer 150, which may, be a C shaped arcuate ring. Coupler 100 comprise front end 101, back end 102, central passage 103 and forward facing annular lip 104, and body 200 comprises front end 201, back end 204 and central passage 202. With regard to front half 11, first insulator 550 is an insulative cylindrical member which positions front end 451 of pin 450 coaxially within body 200, while retainer 500 is a hollow ring that is press fit into body 200 and axially captures first insulator 550 within body 200. Second insulator 600 is an insulative cylindrical member which positions back end 452 of pin 450 coaxially within body 200, while actuator 650, an insulative cylindrical member, may be used to compress insulator 600 radially inwardly.

Back half 12 comprises back nut 250 sleeve 300, ferrule 350, and compression ring 400. Back nut 250 comprises front end 252, back end 298 and central passage 255. Sleeve 300 comprises front end 302, back end 398, outside diameter 306, and a plurality of cogs 304. Ferrule 350 comprises front end 351, back end 388, a plurality of slots 352, raised portion 359 and a plurality of internal annular ridges 356 and 357. Compression ring 400 front end 401, back end 403 and central passage 404. Partial assembly of back half 12 is accomplished by inserting compression ring 400 and ferrule 350 into back nut 250 with back end 388 of ferrule 350 inserted into central passage 404 of compression ring 400. Sleeve 300 is then press fit to a pre-determined depth within central passage 255 of back nut 250 allowing limited axial movement of ferrule 350, and compression ring 400 within back nut 250.

Referring now to FIG. 1A, back half 12 is illustrated as being at least partially installed on coaxial cable 880. Coaxial cable 880 at least partially comprises jacket 881, spiral outer conductor 882, insulator 883 and center conductor 884. During the assembly of back half 12 onto cable 880, ferrule 350 may be positioned onto spiral outer conductor 882 by rotationally engaging internal annular ridges 356 and 357 with spiral outer conductor 882. Pushing back nut 250 in the direction of back end 298 while rotating back nut 250 causes cogs 304 to align with and engage slots 352 at raised portion 359 of ferrule 350 imparting rotational force from back nut 250 to ferrule 350, thereby, threading ferrule 350 onto spiral outer conductor 882 of cable 880. After ferrule 350 is threaded onto spiral outer conductor 882, back nut 250 may be pulled forward in direction of front end 252 disengaging cogs 304 from slots 352 allowing nut 250 to be independently rotated from ferrule 350 and cable 880.

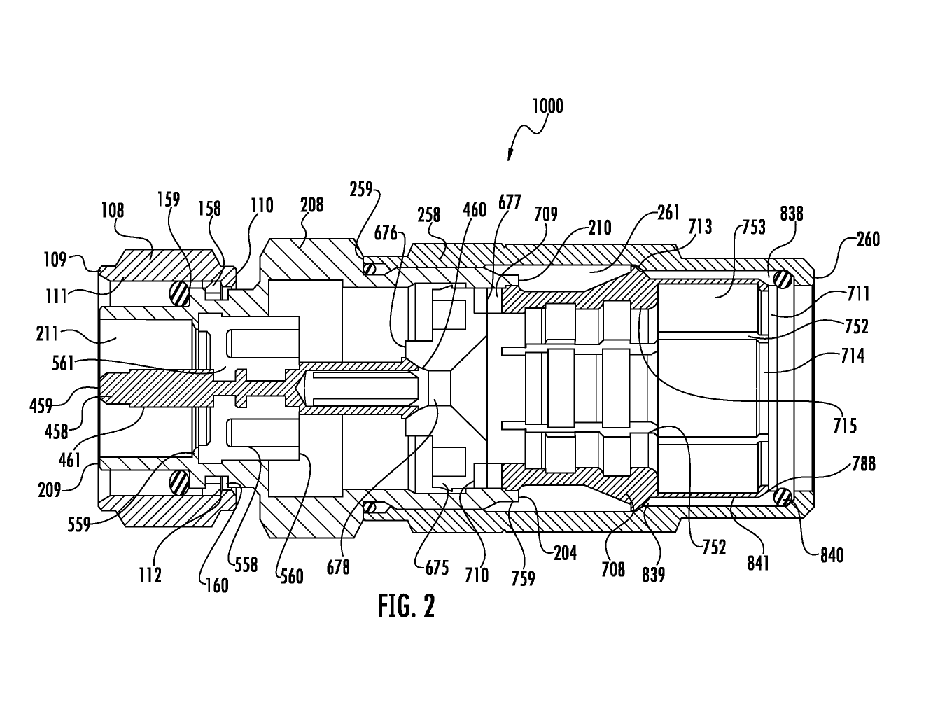

Referring now to FIG. 2, an embodiment of a connector 1000 with an integral locking feature is illustrated. Connector 1000 comprises coupler 108, split retainer 158, body 208, back nut 258, pin 458, insulator 558, insulator 675, ferrule 708, and compression ring 838. Coupler 108 at least partially comprises front end 109, back end 110, central passage 111 and forward facing annular lip 112. Coupler 108 is preferably made of metal such as brass and plated with a conductive material such as nickel-tin. Split retainer 158 at least partially comprises front end 159, back end 160. Split retainer is preferably made of metal such as beryllium copper. Body 208 least partially comprises front end 209, back end 210, at least one cog 204, and central passage 211. The at least one cog 204 may be a plurality of cogs 204. At least one cog 204 of the plurality of cogs 204 may extend axially toward the ferrule 708. Body 209 is preferably made of metal such as brass and plated with a conductive material such as nickel-tin. Back nut 258 at least partially comprises front end 259, back end 260, central passage 261. Back nut 258 is preferably made of metal such as brass and plated with a conductive material such as nickel-tin. Pin 458 at least partially comprises front end 459, back end 460, and shaft 459. Pin 458 is preferably made of metal such as brass and plated with a conductive material such as nickel-tin. Insulator 558 at least partially comprises front end 559, back end 560 and central passage 561. Insulator 558 is preferably made of plastic such as acetal. Insulator 675 at least partially comprises front end 676, back end 677 and central passage 678. Insulator 675 is preferably made of plastic such as acetal. Ferrule 708 at least partially comprises front end 710, back end 711, a plurality of slots 752, slotted portion 753, tapered surface 713, raised annular portion 759 and a plurality of internal annular ridges 714 and 715. Ferrule 708 is preferably made of metal such as brass and plated with a conductive material such as nickel-tin. Compression ring 838 at least partially comprises front end 829, back end 840 and central passage 841. Compression ring 838 is preferably made of metal such as brass and plated with a conductive material such as nickel-tin. As can be seen in FIG. 2, connector 1000 does not include a sleeve 300, as is included in connector 10 of FIGS. 1 and 1A. Thus, connector 1000 does not have a separate component to lock ferrule 708. Instead, connector 1000 has an integral locking feature comprising cogs 204 formed in the body 208 and slots 752 in the raised annular portion 759 of the ferrule 708. The cogs 204 are part of the body 208 in that the cogs 204 are monolithic with the body 208.

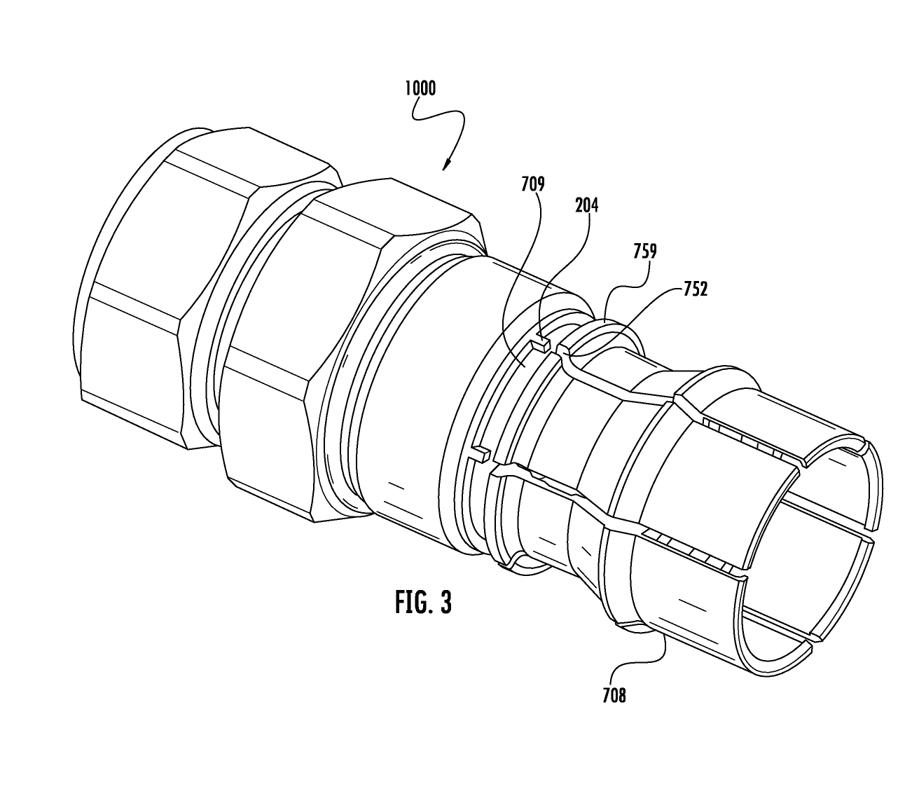

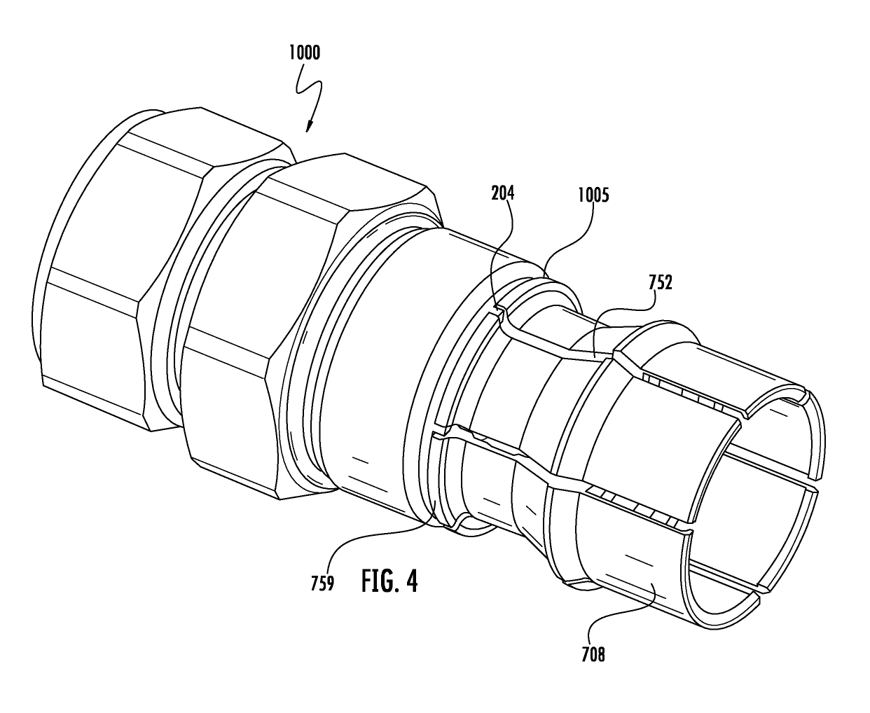

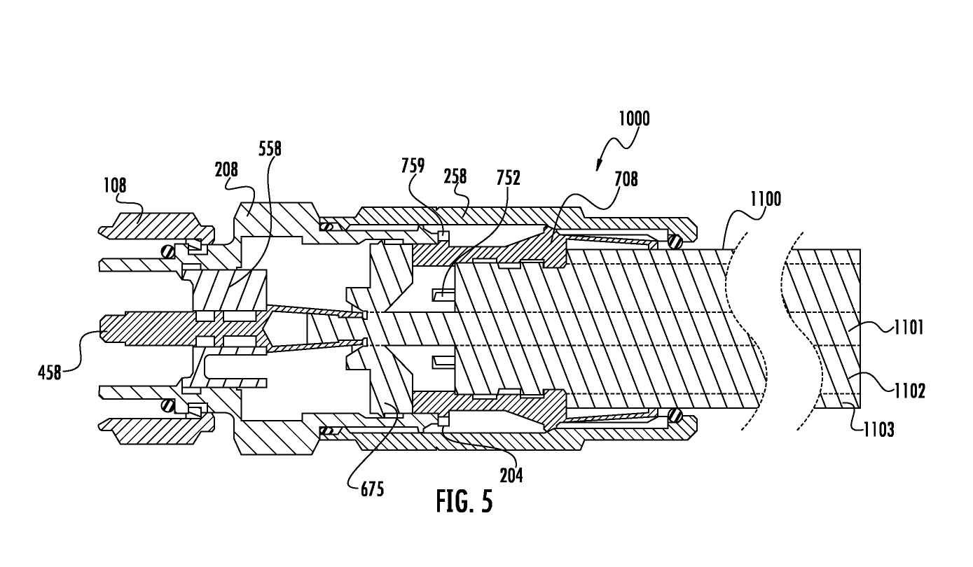

FIGS. 3 and 4 are perspective views of connector 1000 of FIG. 4. FIG. 3 shows slots 752 in raised annular portion 759 of ferrule 708 not engaged with cogs 204. FIG. 4 shows slots 752 in raised annular portion 759 of ferrule 708 engaged with cogs 204 at area 1005. In this regard, as the connector 1000 is closed and tightened with a coaxial cable inserted therein, the cogs 204 position in the slots 752 in the raised annular portion 759. In this way, the at least one cog 204 and the at least one slot 752 act to lock the ferrule 708 in stable position, and, thereby, retain the cable in a stable, non-rotatable position in the connector 1000, as discussed in more detail with reference to FIG. 5.

In this regard, FIG. 5 illustrates connector 1000 installed on coaxial cable 1100. Advancing back nut 258 in the direction of front end 209 drives ferrule 708 engaging cogs 204 with slots 752 proximate raised annular portion 759 of ferrule 708. Upon engagement of cogs 204 with slot 752, ferrule 708 is prevented from rotating relative to body 208 while at the same time back nut 258 is free to rotate relative to both body 208 and ferrule 708. Further advancement of back nut 258 drives compression ring 838 further over ferrule 708 causing back end 788 of ferrule 708 to close radially inwardly about cable jacket 113 and cable insulator 1102. The internal contour of central passage 841 forces slotted portion 753 radially inwardly. The forward movement of ferrule 708 drives front end 710 of ferrule 708 against back end 677 of insulator 675. This, in turn, drives a tapered portion of central passage 678 against back end 460 of pin 458 causing back end 460 of pin 458 to close radially inwardly about center conductor 1101. Prevention of ferrule 708 from rotating relative to body 208 is accomplished without forward and backward movement of back nut 258 and without use of a separate or ancillary component such as sleeve 300 of connector 10 as shown in FIG. 1.

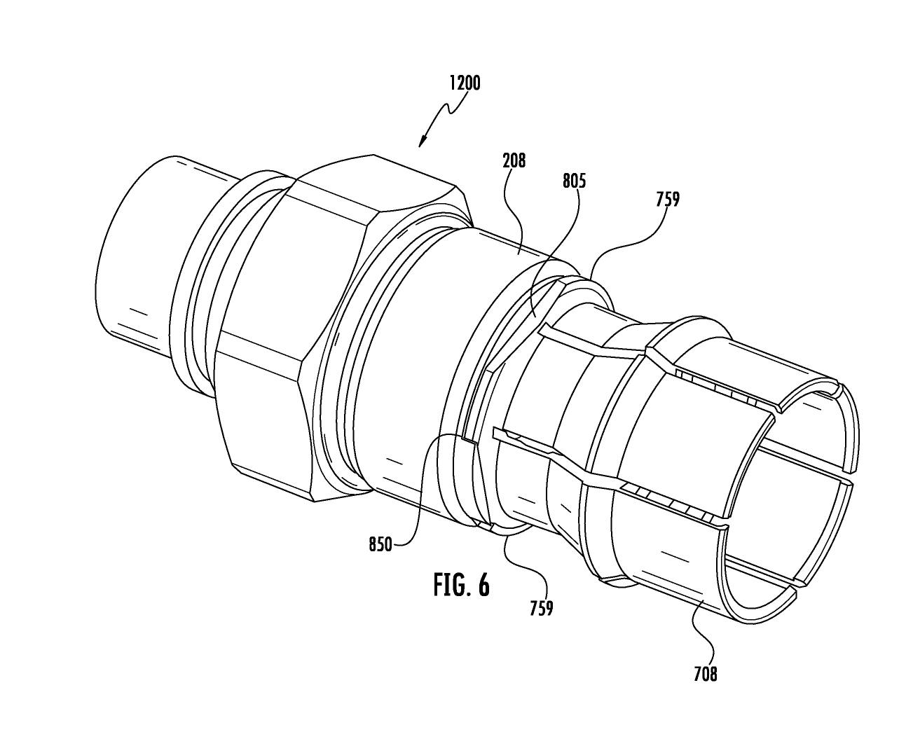

FIG. 6 is a perspective illustration of a partial assembly of connector 1200. Connector 1200 has integral locking feature comprises at least one cog 850 engaging at least one flat 805 formed in raised annular portion 759 of ferrule 708. The at least one cog 850 may be a plurality of cogs 850. At least one cog 850 of the plurality of cogs 850 may extend axially toward the ferrule 708. The at least one flat 805 may be a plurality of flats 805. In a similar manner to the connector 1000 in FIGS. 2-5, cogs 850 are part of and monolithic with body 208. Cogs 850 may be larger than cogs 204 and may have a slightly arcuate shape. As the connector 1200 is closed and tightened with a coaxial cable inserted therein, the cogs 850 position in the flats 752. In this way, the at least one cog 850 and the at least one flat 805 act to lock the ferrule 708 in stable position, and, thereby, retain the cable in a stable, non-rotatable position in the connector 1200. The other components of the connector 1200 assemble and interact in a similar manner as discussed with reference to connector 1000 in FIG. 5.

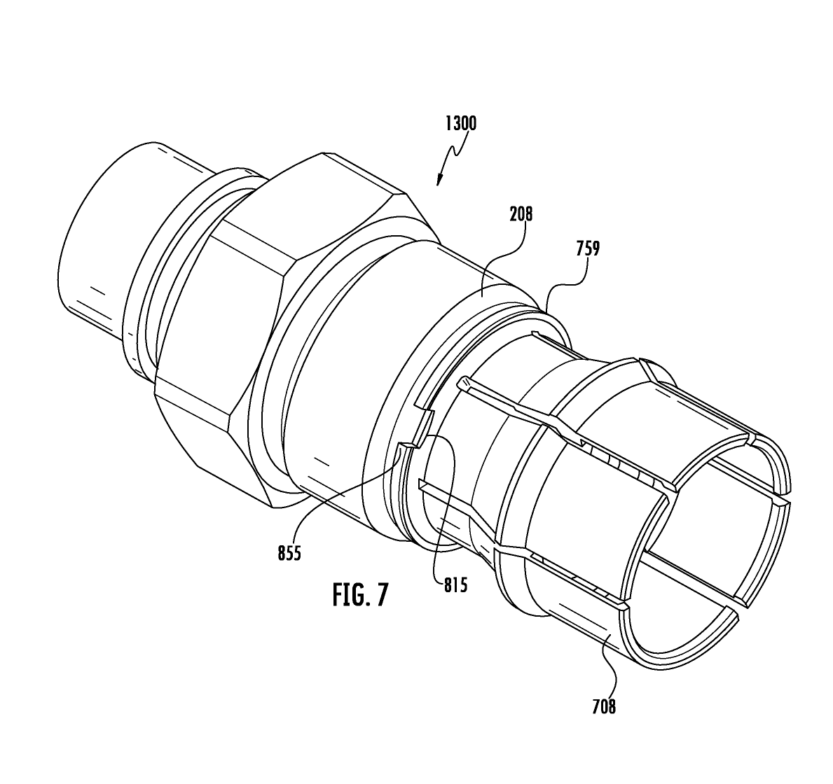

FIG. 7 is a perspective illustration of a partial assembly of connector 1300. Connector 1300 has integral locking feature comprises at least one cog 855 engaging alternate slots 815 on raised annular portion 759 of ferrule 708. The at least one cog 855 may be a plurality of cogs 855. At least one cog 855 of the plurality of cogs 855 may extend axially toward the ferrule 708. In a similar manner to the connector 1000 in FIGS. 2-5, cogs 855 are part of and monolithic with body 208. As the connector 1300 is closed and tightened with a coaxial cable inserted therein, the cogs 855 position in slots 815. In this way, the at least one cog 855 and the at least one slot 815 act to lock the ferrule 708 in stable position, and, thereby, retain the cable in a stable, non-rotatable position in the connector 1300. The other components of the connector 1300 assemble and interact in a similar manner as discussed with reference to connector 1000 in FIG. 5.

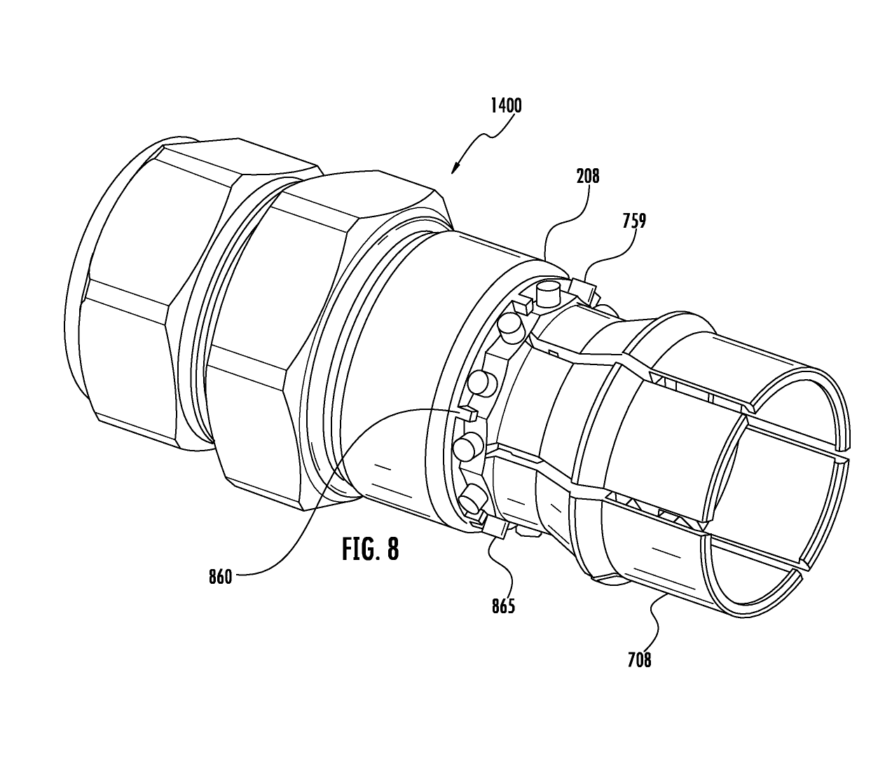

FIG. 8 is a perspective illustration of a partial assembly of connector 1400. Connector 1400 has integral locking feature comprises at least one cog 860 engaging radially extending pegs 865 on raised annular portion 759 of ferrule 708. The at least one cog 860 may be a plurality of cogs 860. At least one cog 860 of the plurality of cogs 860 may extend axially toward the ferrule 708. In a similar manner to the connector 1000 in FIGS. 2-5, cogs 860 are part of and monolithic with body 208. The pegs 865 may extend radially outwardly and be part of and monolithic with the ferrule 708. As the connector 1400 is closed and tightened with a coaxial cable inserted therein, the at least one cog 860 position between adjacent pegs 865. In this way, the at least one cog 860 and pegs 865 act to lock the ferrule 708 in stable position, and, thereby, retain the cable in a stable, non-rotatable position in the connector 1400. The other components of the connector 1400 assemble and interact in a similar manner as discussed with reference to connector 1000 in FIG. 5.

FIG. 15 is a perspective illustration of a partial assembly of connector 1500. Connector 1500 has integral locking feature comprising cogs 870 engaging radial fins 875 on raised annular portion 759 of ferrule 708. In a similar manner to the connector 1000 in FIGS. 2-5, cogs 870 are part of and monolithic with body 208. The fins 875 may extend radially outwardly and be part of and monolithic with the ferrule 708. As the connector 1500 is closed and tightened with a coaxial cable inserted therein, the cogs 870 position between fins 875. In this way, cogs 870 and fins 875 act to lock the ferrule 708 in stable position, and, thereby, retain the cable in a stable, non-rotatable position in the connector 1500. The other components of the connector 1500 assemble and interact in a similar manner as discussed with reference to connector 1000 in FIG. 5.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. A coaxial cable connector for coupling an end of a coaxial cable to a terminal, the coaxial cable comprising an inner conductor, a dielectric surrounding the inner conductor, an outer conductor surrounding the dielectric, and a jacket surrounding the outer conductor, the coaxial cable connector comprising:
a body; and
a ferrule, wherein the body and the ferrule form an integral locking feature, and wherein the integral locking feature lock the ferrule in stable position, and retain a cable in a stable, non-rotatable position in the connector when the cable is inserted in the connector and the connector is tightened.

2. The coaxial cable connector of claim 1, wherein the integral locking feature is monolithic with at least one of the body and the ferrule.

3. The coaxial cable connector of claim 1, wherein the integral locking feature comprises at least one cog which is part of and monolithic with the body.

4. The coaxial cable connector of claim 3, wherein the at least one cog extends axially toward the ferrule.

5. The coaxial cable connector of claim 3, wherein the at least one cog comprises a plurality of cogs.

6. The coaxial cable connector of claim 1, wherein the integral locking feature comprises at least one slot formed in the ferrule.

7. The coaxial cable connector of claim 6, wherein the at least one slot is formed a in raised annular portion in the ferrule.

8. The coaxial cable connector of claim 6, wherein the at least one slot comprises a plurality of slots.

9. The coaxial cable connector of claim 6, wherein at least one cog in the body is adapted to engage with the at least one slot when the connector is tightened by positioning in the at least one slot.

10. The coaxial cable connector of claim 1, wherein the integral locking feature comprises at least one peg formed in the ferrule and extending radially outwardly.

11. The coaxial cable connector of claim 10, wherein the at least one peg comprises a plurality of pegs.

12. The coaxial cable connector of claim 11, wherein at least one cog in the body is adapted to engage with the plurality of peg when the connector is tightened by positioning between adjacent pegs of the plurality of pegs.

13. The coaxial cable connector of claim 1, wherein the integral locking feature comprises at least one flat formed in the ferrule.

14. The coaxial cable connector of claim 13, wherein the at least one flat is formed a in raised annular portion in the ferrule.

15. The coaxial cable connector of claim 13, wherein the at least one flat comprises a plurality of flats.

16. The coaxial cable connector of claim 13, wherein at least one cog in the body is adapted to engage with the at least one flat when the connector is tightened by positioning at the at least one flat.
